(19) United States
(12) Patent Application Publication
(10) Pub. No.: US 2011/0064615 A1
(43) Pub. Date: Mar. 17, 2011

(54) PIEZOELECTRIC SENSOR AND SENSING INSTRUMENT

(76) Inventors: Shigenori Watanabe, Saitama (JP); Takeru Mutoh, Saitama (JP); Mitsuaki Koyama, Saitama (JP)

(21) Appl. No.: 12/736,822

(22) PCT Filed: Mar. 2, 2009
(86) PCT No.: PCT/JP2009/054358

§ 371 Date: Nov. 12, 2010

(51) Int. Cl. G01N 30/00

(52) U.S. Cl. 422/69

(57) ABSTRACT

An object of the present invention is to improve detecting ability of a piezoelectric sensor.

The present invention, in a piezoelectric sensor having electrodes that are each made of a gold layer formed on one surface side and the other surface side of a piezoelectric piece via adhesive layers by sputtering respectively, and having an adsorption layer that is composed of an antibody provided on a front surface of the electrode on the one surface side, and having the electrode on the other surface side provided to face an airtight space, and detecting an antigen adsorbed to the antibody in accordance with a change in an oscillation frequency of the piezoelectric piece, includes: conductive paths connecting the electrodes to an oscillator circuit; and a conductive adhesive provided over the electrodes and the conductive paths in order to fix the electrodes to the conductive paths and having a binder cure in a state where a conductive filler is joined to the gold layer, and a thickness of the gold layer is set to be equal to or more than 3000 Å.

### TECHNICAL FIELD

The present invention relates to a piezoelectric sensor having an adsorption layer that is composed of an antibody provided on a front surface of an electrode formed on one surface side of a piezoelectric piece and for detecting an antigen adsorbed to the antibody by an antigen-antibody reaction in accordance with a change in an oscillation frequency of the piezoelectric piece, and to a sensing instrument using the above piezoelectric sensor.

### BACKGROUND ART

As a method for sensing presence/absence of a trace substance, an environmental pollutant such as, for example, a mouse IGg, or a disease marker such as a hepatitis C virus and a C-reactive protein (CPR), in a sample solution, or for measuring these substances, there has been widely known a measurement method using: a quartz-crystal sensor that includes a quartz-crystal resonator; and a measuring device that is electrically connected to the above quartz-crystal sensor and includes an oscillator circuit or the like for oscillating the quartz-crystal resonator (for example, Patent Document 1).

To explain concretely, in the measurement method, the quartz-crystal sensor including the quartz-crystal resonator called a Langevin-type resonator that is provided with, for example, a plate-shaped quartz-crystal piece, and a pair of foil-shaped electrodes for excitation provided on one surface side and the other surface side of the quartz-crystal piece to sandwich the quartz-crystal piece respectively is structured so that the electrode on the one surface side comes into contact with a measurement atmosphere (sample solution) and the electrode on the other surface side faces an airtight space, an antibody capturing an antigen by an antigen-antibody reaction is formed as an adsorption layer on a front surface of the electrode on the one surface side, and the method utilizes a property that when the antigen is captured to the above adsorption layer, a natural frequency of the quartz-crystal resonator changes in accordance with an adsorption amount of the antigen. Then, a difference between the natural frequency of the quartz-crystal resonator before the antigen is absorbed to the adsorption layer and the natural frequency of the quartz-crystal resonator after the antigen is absorbed to the adsorption layer, namely a change amount, is obtained, and presence/absence or a concentration of a substance to be measured is detected in accordance with the above change amount.

FIG. 10 shows one example of a structure of the periphery of the quartz-crystal resonator provided in the quartz-crystal sensor. In FIG. 10, 11 denotes a wiring substrate, and the quartz-crystal resonator 10 is placed on the above wiring substrate 11. The above quartz-crystal resonator 10 has electrodes 13 for excitation provided on one surface side and the other surface side of a plate-shaped quartz-crystal piece 12, and the electrodes 13 are electrically connected to electrodes 11a provided on a wiring substrate 11 side via conductive adhesives 14 each made of a conductive filler and a binder.

In FIG. 10, 15 denotes a through hole bored in the wiring substrate 11 in a thickness direction, and in FIG. 10, 15a denotes a sealing member covering the through hole 15 from a rear surface side of the substrate 11. A region surrounded by the sealing member 15a, the through hole 15, and the quartz-crystal resonator 10 forms an airtight space, and the electrode 13 on the rear surface side of the quartz-crystal resonator 10 faces the above airtight space. In FIG. 10, 16 denotes a plate-shaped quartz-crystal pressing member made of, for example, rubber or the like, and it presses the quartz-crystal resonator 10 toward the substrate 11 to fix a position of the quartz-crystal resonator 10.

In FIG. 10, 17 denotes an opening portion provided to penetrate the quartz-crystal pressing member 16 in the thickness direction and it faces the electrode 13 on the front surface side of the quartz-crystal resonator 10. In FIG. 10, 18 denotes an annular projection of the quartz-crystal pressing member 16. Then, a predetermined amount of a sample solution is stored in a solution storage space 19 surrounded by the opening portion 16 and the annular projection 18, and thereby the electrode 13 comes into contact with a measurement atmosphere.

Further, the electrodes 13 provided on the one surface side and the other surface side of the quartz-crystal piece 12 of the quartz-crystal resonator 10 are each composed of, as shown in FIG. 11, two layers, which are a gold (Au) layer 100 and a base layer 101 made of metal such as, for example, chromium (Cr) or nickel (Ni), in general. The above two layers are formed by, for example, sputtering. The reason why gold is used for the upper layer is to oscillate quartz-crystal effectively, and the reason why metal such as chromium or nickel is used for the lower layer is to increase adhesion force between the gold layer 100 and the quartz-crystal piece 12. Then, a film thickness of the gold layer 100 is set to 2000 Å in order to oscillate the quartz-crystal piece 12 stably, and a film thickness of the base layer 101 is set to 100 Å in order to obtain adhesion between the quartz-crystal piece 12 and the gold layer 100 sufficiently.

Further, conventionally, in order to join the electrodes 11a on the wiring substrate 11 and the electrodes 13 for excitation on the quartz-crystal resonator 10, the conductive adhesive 14 in which a conductive filler made of, for example, silver (Ag) is dispersed in a silicone resin being a binder is used. However, with the above conductive adhesive 14, after the resin in the periphery of Ag first cures, the resin in the periphery of a front surface portion of the gold layer 100 cures, and thus Ag that has been joined to a front surface of the gold layer 100 moves in a direction of going away from the front surface of the gold layer 100 due to curing shrinkage, and consequently a resin film is formed on the front surface of the gold layer 100 to hamper a current-carrying characteristic. Thus, by precipitating the metal of the base layer 101, which is, for example, chromium, to the front surface of the gold layer 100 by means of thermal diffusion and utilizing the fact that the resin in the periphery of Ag and the resin in the periphery of a Cr front surface portion cure at the same speed, the movement of Ag due to curing shrinkage has been suppressed (Patent Document 2).

However, in the quartz-crystal sensor, as shown in FIG. 11, antibodies 201 each capturing an antigen 200 by an antigen-antibody reaction are attached to the front surface of the electrode 13 to thereby form an adsorption layer 202, and thus the following problem occurs when chromium is precipitated to the front surface of the gold layer 100. That is, the antibody 201, which is, for example, a protein or the like, easily attaches to gold but does not easily attach to chromium, so that if chromium is precipitated to the front surface of the gold layer 100, an attachment amount of the antibody 201 on the front surface of the electrode 13 is reduced to reduce detecting ability of the quartz-crystal sensor. Thus, it has been considered that such thermal diffusion processing is not performed, and as the conductive adhesive 14, one in which a binder cures in a state where a conductive filler is joined to the front surface of the gold layer 100 is used. Concretely, the conductive adhesive 14 with a conductive filler made of, for example, silver and a binder made of an epoxy resin has been used. Incidentally, in recent years, the quartz-crystal sensor has been required to detect a trace substance of, for example, dioxin or the like with high precision, and it has been necessary to respond to such a requirement.

On the other hand, Patent Document 3 has described that in annealing processing, a mold process or the like to be performed after joining a connection electrode (lead) to an electrode film formed on a front surface of a quartz-crystal piece by a solder, a solder component diffused on a front surface of the electrode film diffuses into the electrode film in a joining process, and thus in order to prevent the above, chromium is formed on an upper surface of the electrode film and such a chromium component is thermally diffused in the electrode film in a film thickness direction. Further, it has been described that, in this invention, a film thickness of the electrode film is set to not less than 1000 Å nor more than 5000 Å, but there has been no description with regard to the above-described problem.

### PRIOR ART DOCUMENT

### Patent Document 1 Japanese Patent Application Laid-open No. 2001-194866

Patent Document 2 Japanese Patent Application Laid-open No. 2000-151345 (paragraph 0006 to paragraph 0008, paragraph 0014 and paragraph 0015)
Patent Document 3 Japanese Patent Application Laid-open No. 2002-50937 (paragraph 0012 and paragraph 0067)

### SUMMARY OF THE INVENTION

The present invention has been made under such circumstances, and an object thereof is, in a piezoelectric sensor having an adsorption layer that is composed of an antibody provided on a front surface of an electrode that is formed on one surface side of a piezoelectric piece and for detecting an antigen adsorbed to the antibody by an antigen-antibody reaction in accordance with a change in an oscillation frequency of the piezoelectric piece, to improve detecting ability of the piezoelectric sensor.

The present invention is characterized in that a piezoelectric sensor for sensing an antigen in a sample solution based on a natural frequency of a piezoelectric resonator, the piezoelectric sensor includes:

a holder having a hole portion formed therein;

a piezoelectric resonator having electrodes that are each made of a gold layer formed on one surface side and the other surface side of a piezoelectric piece via adhesive layers respectively and provided to cover the hole portion and to make the electrode on the other surface side face the hole portion;

an antibody provided on a front surface of the electrode on the one surface side and capturing an antigen by an antigen-antibody reaction; and

conductive paths for connecting the electrodes to an oscillator circuit, and in which

the gold layer on the one surface side is one formed to be a film having a thickness that is equal to or more than 3000 Å by sputtering.

Concrete examples of the above-described piezoelectric sensor are cited. The holder is a wiring substrate provided with the conductive paths,

in order to connect the electrodes to the conductive paths, a conductive adhesive is provided over the electrodes and the conductive paths, and

the adhesive contains a conductive filler and a binder made of an epoxy resin. The adhesive layer is preferably at least one type selected from, for example, chromium, titanium, nickel, aluminum, and copper.

Further, a sensing instrument of the present invention includes: the piezoelectric sensor of the present invention; and a measuring device main body for detecting the natural frequency of the piezoelectric resonator.

According to the present invention, the thickness of the gold layer in the electrode formed on the front surface of the piezoelectric piece is set to 3000 Å or more, and thereby an adsorption amount of an antigen to the adsorption layer formed on the front surface of the gold layer is increased as shown in later-described examples. It is inferred that this is because, by sputtering, gold atoms are deposited to increase the thickness of the gold layer, and thereby the front surface of the gold layer is coarsened to increase a contact area with the antibody on the front surface of the gold layer, and when the adsorption layer is formed on the front surface of the gold layer, an amount of the antibody to attach to the front surface of the gold layer is increased. That is, it is considered that by increasing the thickness of the gold layer, an attachment amount of the antibody on the front surface of the gold layer is increased, and thereby it becomes possible to capture a larger number of the antigens by the antibodies.

### BRIEF DESCRIPTION OF DRAWINGS

FIG. 1 is a vertical cross-sectional view of a quartz-crystal sensor according to an embodiment of the present invention;

FIG. 2 is a cross-sectional view showing a structure of a quartz-crystal piece according to the embodiment of the present invention;

FIG. 3 is a conceptual diagram explaining an adsorption layer to be formed on a front surface of an electrode of the quartz-crystal piece;

FIG. 4(a) and FIG. 4(b) are conceptual diagrams each explaining formation of an adsorption layer on a front surface of a gold layer;

FIG. 5 is a perspective view of the quartz-crystal sensor;

FIG. 6 is an exploded perspective view of the quartz-crystal sensor;

FIG. 7 is a perspective view of a rear surface side of a quartz-crystal pressing member constituting the quartz-crystal sensor;

FIG. 8 is a block diagram of a sensing instrument including the quartz-crystal sensor;

FIG. 9 is an explanatory graph showing a result of experiments performed to confirm an effect of the present invention;

FIG. 10 is a schematic vertical side view showing a substantial part of a conventional quartz-crystal sensor; and

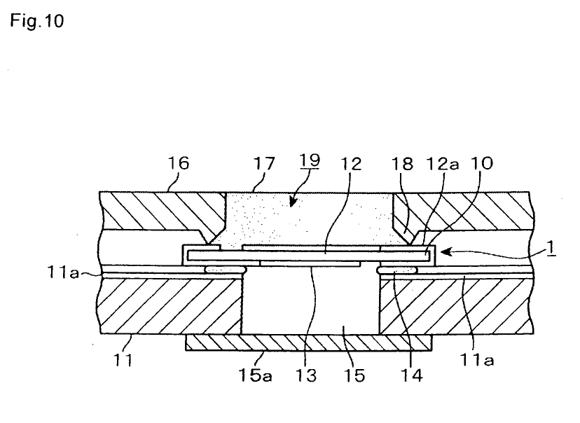

FIG. 11 is a conceptual diagram explaining an adsorption layer to be formed on a front surface of an electrode of a quartz-crystal piece shown in FIG. 10.

### BEST MODE FOR CARRYING OUT THE INVENTION

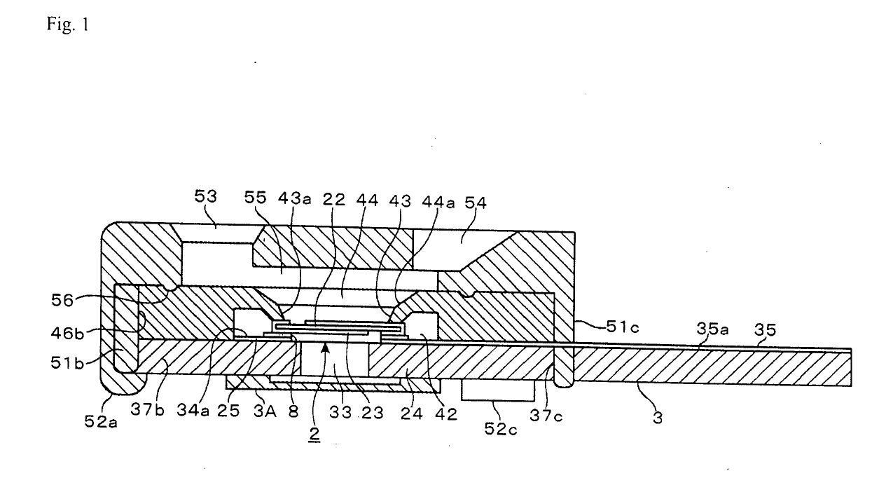

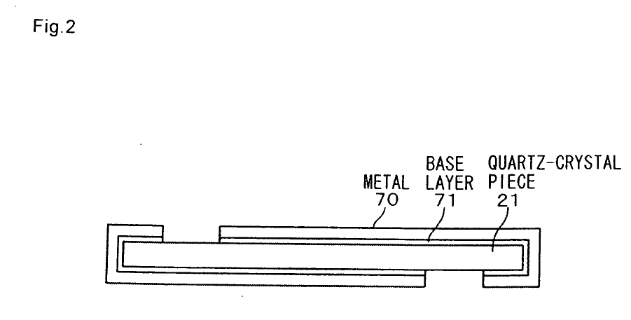

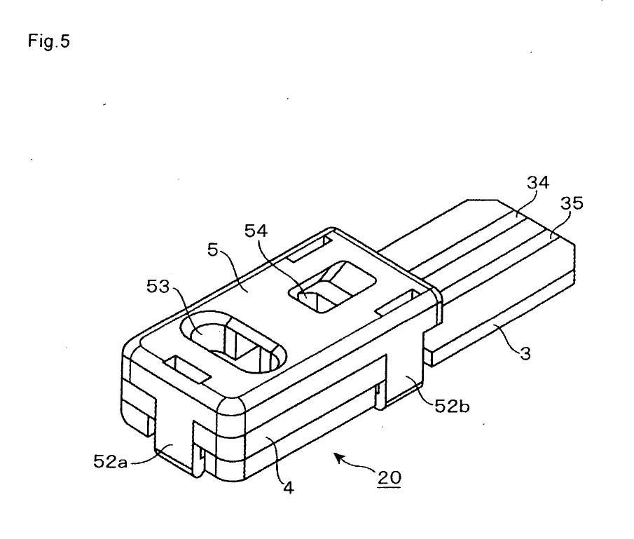

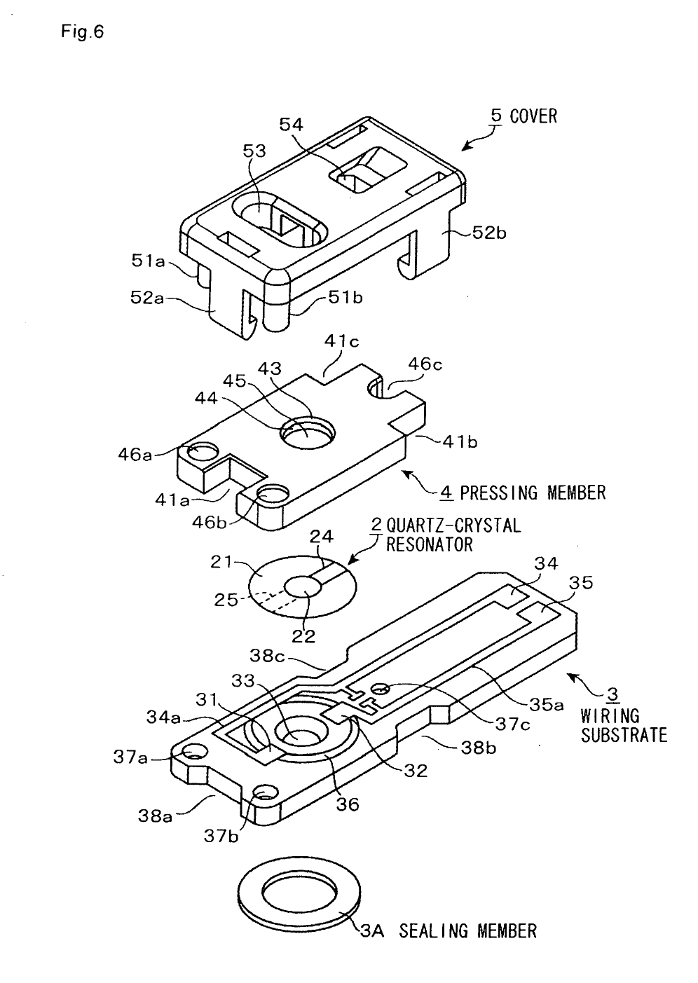

An embodiment of a quartz-crystal sensor being one example of a piezoelectric sensor according to the present invention will be explained with reference to FIG. 1 to FIG. 7. FIG. 1 is a vertical cross-sectional view showing a quartz-crystal sensor 20 being one example of the piezoelectric sensor according to the present invention, and FIG. 2 is a plan view showing a structure of a quartz-crystal resonator 2 being a piezoelectric resonator provided in the piezoelectric sensor. Further, FIG. 5 is a perspective view of the quartz-crystal sensor 20, and FIG. 6 is an exploded perspective view showing upper surface sides of respective components of the quartz-crystal sensor 20. As shown in FIG. 1, FIG. 5, and FIG. 6, the quartz-crystal sensor 20 is structured in a manner that respective components of a sealing member 3A, a wiring substrate 3 being a holder, the quartz-crystal resonator 2, a quartz-crystal pressing member 4, and a solution injection cover 5 are stacked in this order from the bottom.

As shown in FIG. 1, the quartz-crystal resonator 2 has electrodes 22, 23 for excitation formed on one surface side and the other surface side of a quartz-crystal piece 21 being a piezoelectric piece. The electrode 22 formed on the one surface side of the quartz-crystal piece 21 is continuously formed on a peripheral edge portion of the other surface side, and the electrode 23 formed on the other surface side of the quartz-crystal piece 21 is continuously formed on a peripheral edge portion of the one surface side. As shown in FIG. 2, the electrodes 22, 23 are each formed in a manner that a gold (Au) layer 70 for efficiently oscillating quartz-crystal and a base layer 71 being an adhesive layer made of metal selected from, for example, chromium (Cr), titanium (Ti), nickel (Ni), aluminum (Al), and copper (Cu) for increasing adhesion force between the gold layer 70 and the quartz-crystal piece 21 are stacked in order from the base layer 71.

Further, a thickness of the gold layer 70 is set to 3000 Å or more, and is set to 3000 Å in this example, and the thickness of the gold layer 70 is set to such a size, thereby increasing an adsorption amount of an antigen 74 to an adsorption layer 7 formed on a front surface of the gold layer 70 as shown in later-described examples. As a reason why the adsorption amount of the antigen 74 to the adsorption layer 7 is increased, it is inferred that this is because, as will be described later, by sputtering, gold atoms are deposited on a front surface of the base layer 71 to increase the thickness of the gold layer 70, namely, gold atoms are newly deposited on irregularly deposited gold atoms and the above deposition is performed repeatedly to form the gold layer 70 having the thickness of 3000 Å, so that consequently the front surface of the gold layer 70 is coarsened to thereby increase a contact area with an antibody 72 on the front surface of the gold layer 70, resulting that, when the adsorption layer 7 is formed on the front surface of the gold layer 70 as will be described later, an amount of the antibody 72 to attach to the front surface of the gold layer 70 is increased.

An upper limit value of the thickness of the gold layer 70 is set to 10000 Å, and in the case when the thickness is increased more than this, an oscillation frequency jump easily occurs in the quartz-crystal resonator 2. Further, a thickness of the base layer 71 is set to 10 to 500 Å in order to sufficiently obtain adhesion between the quartz-crystal piece 21 and the gold layer 70, and is set to 100 Å in this example. As for the electrodes 22, 23, for example, the base layer 71 and the gold layer 70 are stacked on the entire both surfaces of the quartz-crystal piece 21 in this order by sputtering, and next a mask with a predetermined pattern is formed on the both surfaces of the quartz-crystal piece 21 to perform etching, and thereby electrode patterns with a two-layer structure are obtained.

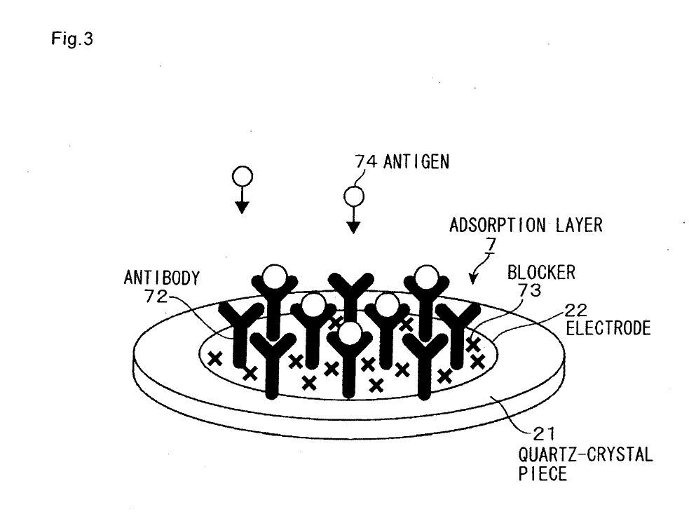

Further, as will be described later, the electrode 22 is provided to face a solution storage space 45 to which a sample solution is supplied, and thus as shown in FIG. 3, the antibodies 72 to capture the antigens 74 by an antigen-antibody reaction are formed as the adsorption layer 7 on the electrode 22, and further substances for blocking (blockers) 73 are adsorbed to spaces between the antibodies 72 facing one another so that the antigen 74 being a substance to be measured is not adsorbed to the front surface of the electrode 22.

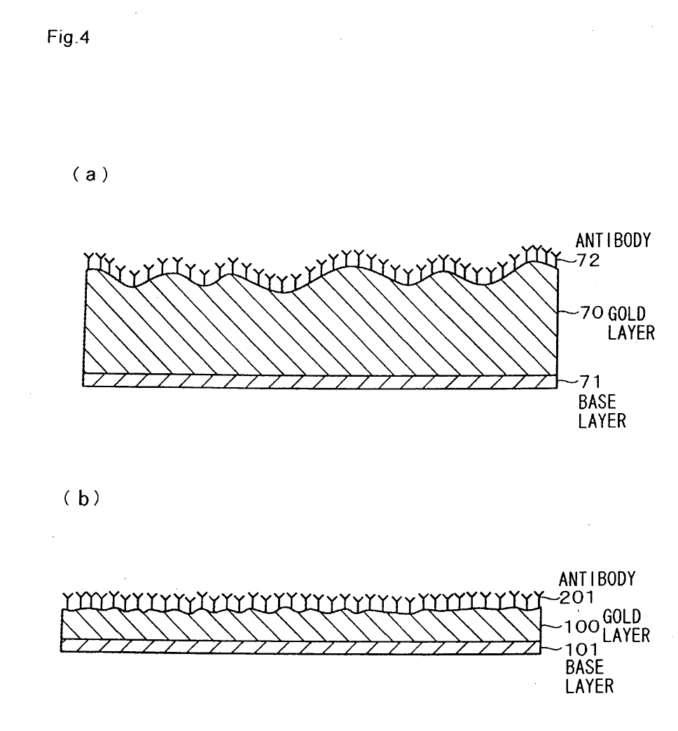

Here, the formation of the adsorption layer 7 on the front surface of the gold layer 100 will be described in detail. In this embodiment, as described previously, by sputtering, gold is applied to the front surface of the base layer 71 to form a film and the gold layer 70 having the thickness of 3000 Å is formed, thereby coarsening the front surface of the gold layer 70 to increase a contact area with the antibody 72 on the front surface of the gold layer 70, resulting that, as shown in FIG. 4(a), a large number of the antibodies 74 come to attach to the front surface of the gold layer 70. On the other hand, a gold layer 100 constituting electrodes 13 on a quartz-crystal resonator 12 to be used for a conventional quartz-crystal sensor has a thickness smaller than that of the gold layer 70 in this embodiment, so that a front surface of the gold layer 100 is hardly coarsened, and as shown in FIG. 4(b), an attachment amount of an antibody 201 on the front surface of the gold layer 100 is reduced as compared with that of the antibody 74 on the front surface of the gold layer 70 in this embodiment. That is, by increasing the thickness of the gold layer 70, an attachment amount of the antibody 74 on the front surface of the gold layer 70 is increased.

Next, the wiring substrate 3 being a holder holding the quartz-crystal resonator will be explained. The above wiring substrate 3 is formed by, for example, a printed circuit board, and an electrode 31 and an electrode 32 are provided to be apart from each other in a direction from a front end side toward a rear end side on a front surface of the wiring substrate 3. Further, as shown in FIG. 1, conductive adhesives 8 each made of a conductive filler and a binder are bonded to regions where the electrodes 31, 32 of the wiring substrate 3 are provided, and as will be described later, the electrodes 22, 23 formed on the peripheral edge portion of the other surface side of the quartz-crystal piece 21 are set to overlap the electrodes 31, 32 on a wiring substrate 3 side via the conductive adhesives 8. As the conductive adhesive 8, one in which a binder cures in a state where a conductive filler is joined to the front surface of the gold layer 100 is used, and concretely the conductive adhesive 8 with a conductive filler made of, for example silver or gold, which is made of silver (Ag) in this example, and a binder made of an epoxy resin is used.

Here, the conductive adhesive 8 to be used in this embodiment will be explained in detail. The above conductive adhesive 8 uses an epoxy resin with a fast curing speed as a binder, so that a timing that the resin in the periphery of Ag cures and a timing that the resin in the periphery of a front surface portion of the gold layer 70 cures are substantially the same, and as a result, in a state where Ag is joined to the front surface of the gold layer 70, the resin rapidly cures. Thus, in the conductive adhesive 8 to be used in this embodiment, as has also been described in “Conventional Art”, a phenomenon that since the curing speed of the resin in the periphery of the front surface portion of the gold layer 100 is slower than that of the resin in the periphery of Ag, Ag joined to the front surface of the gold layer 70 moves in a direction of going away from the front surface of the gold 100 due to curing shrinkage does not occur.

The wiring substrate 3 will be explained again, and between the electrodes 31 and 32 on the wiring substrate 3, a through hole 33 being a hole portion bored in the wiring substrate 3 in the thickness direction is formed to be apart from the electrodes 31, 32. As will be described later, the above through hole 33 forms a recessed portion to be an airtight space faced by the electrode 23 on the rear surface side of the quartz-crystal resonator 2. Note that the hole portion may also be formed not to be penetrated to be a recessed portion having a bottom portion, but it is preferably a through hole. Further, at positions closer to the rear end side than a place where the electrode 32 is formed, two parallel line-shaped conductive path patterns are formed as connection terminal portions 34, 35 respectively. The connection terminal portion 34 is electrically connected to the electrode 31 via a pattern 34a, and the other connection terminal portion 35 is electrically connected to the electrode 32 via a pattern 35a.

In FIG. 6, 36 denotes a weir and the weir 36 serves to fix the position of the quartz-crystal resonator 2, and the quartz-crystal resonator 2 is placed on a region surrounded by the weir 36. In FIGS. 6, 37a, 37b, and 37c denote engagement holes, and they are bored in the wiring substrate 3 in the thickness direction. These engagement holes 37a, 37b, and 37c are engaged with engagement projections 51a, 51b, and 51c provided on a lower surface of the cover 5 respectively. Further, in FIGS. 6, 38a, 38b, and 38c denote cutout portions formed in a peripheral edge portion of the wiring substrate 3, and they are engaged with claw portions 52a, 52b, and 52c bending inward and provided on a peripheral edge portion of the lower surface of the cover 5 respectively. The sealing member 3A is a film member and together with the through hole 33, it forms the recessed portion to be the airtight space.

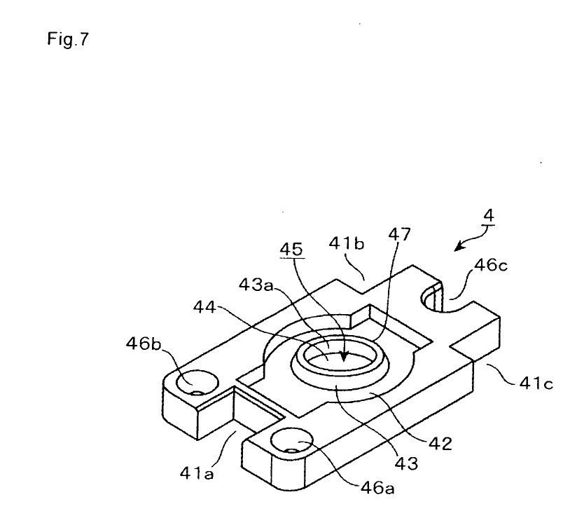

In FIG. 6 and FIG. 7, 4 denotes the quartz-crystal pressing member, and the quartz-crystal pressing member 4 is formed in a plate shape provided with rectangular-shaped cutout portions 41a, 41b, and 41c corresponding to the cutout portions 38a, 38b, and 38c respectively. Further, as shown in FIG. 1 and FIG. 7, in a lower surface of the quartz-crystal pressing member 4, a recessed portion 42 housing the quartz-crystal resonator 2 is formed. At a center of a ceiling surface portion (a bottom surface portion if the description is based on the direction in FIG. 7) of the above recessed portion 42, an annular projection 43 slightly larger than the through hole 33 in the upper surface of the wiring substrate 3 is provided. In a front surface side of the quartz-crystal pressing member 4, an opening portion 44 is formed, and the above opening portion 44 communicates with a space surrounded by the annular projection 43.

A peripheral side surface 44a of the opening portion 44 and an inner peripheral side surface 43a of the annular projection 43 are inclined inward/downward, and a tip portion 47 of the annular projection 43 presses the peripheral edge portion of the quartz-crystal piece 20. A region surrounded by the peripheral side surfaces 43a, 44a and the quartz-crystal resonator 2 forms the solution storage space 45 storing the sample solution.

Further, in FIG. 6, 46a, 46b denote engagement holes bored to penetrate the pressing member 4 in the thickness direction, and they are formed to correspond to the engagement holes 37a, 37b of the wiring substrate 3 and the engagement projections 51a, 51b of the solution injection cover 5. In FIG. 6, 46c denotes an arc-shaped cutout portion formed at a center of a rear-side edge, and it corresponds to the engagement hole 37c of the wiring substrate 3 and the engagement projection 51c of the solution injection cover 5.

At a front side and a rear side on an upper surface of the cover 5, an injection port 53 and a check port 54 for the sample solution are formed respectively. In the lower surface of the cover 5, an injection channel 55 that is a groove is formed along a longitudinal direction of the cover 5, and one end and the other end of the above injection channel 55 are connected to the injection port 53 and the check port 54 respectively. Further, the injection channel 55 is provided to face the opening portion 44, and the sample solution injected into the injection port 53 is supplied to the solution storage space 45 through the injection channel 55. Further, on the lower surface of is the cover 5, an annular weir 56 surrounding the injection channel 55 is provided to prevent the sample solution from leaking.

The above-described quartz-crystal sensor 20 is assembled in the following manner. First, the through hole 33 in the wiring substrate 3 is covered by the sealing member 3A to form the recessed portion in the substrate 3. Subsequently, a predetermined amount of the conductive adhesive 8 is applied to the front surfaces of the electrodes 31, 32 on the wiring substrate 3. Thereafter, the quartz-crystal resonator 2 is placed on the wiring substrate 3 so that the electrodes 22, 23 formed on the peripheral edge portion of the other surface side of the quartz-crystal piece 21 overlap the electrodes 31, 32 on the wiring substrate 3 side and the electrode 23 formed on a center portion of the other surface side of the quartz-crystal piece overlaps the recessed portion.

Next, after the solution injection cover 5 and the pressing member 4 are stacked on each other by engaging the engagement projections 51a to 51c of the solution injection cover 5 with the engagement holes 46a, 46b and the cutout portion 46c of the quartz-crystal pressing member 4, they are stacked on the wiring substrate 3 so that the claw portions 52a, 52b, and 52c of the solution injection cover 5 and the cutout portions 38a, 38b, and 38c of the wiring substrate 3 are fit to each other, and are pressed toward the wiring substrate 5. Thereby, the claw portions 52a to 52c of the solution injection cover 5 each bend toward an outer side of the wiring substrate 3, and as soon as the claw portions 52a to 52c further reach the lower surface of the peripheral edge portion of the wiring substrate 3 via the cutout portions 38a to 38c respectively, the claw portions 52a to 52c return to the original shape due to its inward restoring force respectively, and as soon as the wiring substrate 3 is sandwiched by the respective claw portions 52a to 52c to be caught thereby, the pressing member 4 sandwiched between the wiring substrate 3 and the cover 5 is pressed by them.

Due to elasticity of the pressed pressing member 4, the annular projection 43 presses a portion, of the front surface of the quartz-crystal resonator 2, outside the recessed portion toward the wiring substrate 3 side, so that the position of the quartz-crystal resonator 2 is fixed, the peripheral edge portion thereof comes into close contact with the wiring substrate 3 to turn the recessed portion formed by the through hole 33 and the sealing member 3A into an airtight space, the electrode 23 formed on the center portion of the other surface side of the quartz-crystal piece 21 faces the above airtight space, the conductive adhesives 8 formed on the front surfaces of the electrodes 31, 32 of the wiring substrate 3 and the electrodes 22, 23 formed on the peripheral edge portion of the other surface side of the quartz-crystal piece 21 are bonded, and thereby the electrodes 22, 23 and the electrodes 31, 32 on the wiring substrate 3 side are electrically connected respectively.

Next, an operation of the above-described quartz-crystal sensor 20 will be explained. First, an operator injects the sample solution into the injection port 53 of the solution injection cover 5 by using, for example, an injector. The sample solution injected into the injection port 53 is supplied to the solution storage space 45 for the sample solution formed by the opening portion 44 and the annular projection 43, and the electrode 22 on the front surface side of the quartz-crystal resonator 2 comes into contact with the sample solution, and the antigen 74 in the sample solution is adsorbed to the adsorption layer 7 composed of the antibodies 72 formed on the front surface of the electrode 22 by an antigen-antibody reaction. Then, when the antigen 74 is adsorbed to the adsorption layer 7, a natural frequency of the quartz-crystal resonator 2 reduces in accordance with an adsorption amount of the antigen 74. Thereby, a difference between the natural frequency of the quartz-crystal resonator 2 before the antigen 74 is adsorbed to the adsorption layer 7 and the natural frequency of the quartz-crystal resonator 2 after the antigen 74 is adsorbed to the adsorption layer 7, namely a change amount, is obtained.

According to the above-described embodiment, in the electrodes 22, 23 formed on the front surface of the quartz-crystal piece 21, the thickness of the gold layer 70 is set to 3000 Å, and is set to 3000 Å in this example, and thereby an adsorption amount of the antigen 74 to the adsorption layer 7 formed on the front surface of the gold layer 70 is increased as shown in the later-described examples. It is inferred that this is because, since, as described above, by sputtering, gold atoms are deposited on the front surface of the base layer 71 to increase the thickness of the gold layer 70, namely gold atoms are newly deposited on gold atoms deposited irregularly and the above deposition is performed repeatedly to form the gold layer 70 having the thickness of 3000 Å, consequently the front surface of the gold layer 70 is coarsened to increase a contact area with the antibody 72 on the front surface of the gold layer 70, and when the adsorption layer 7 is formed on the front surface of the gold layer 70 as will be described later, an amount of the antibody 72 to attach to the front surface of the gold layer 70 is increased. That is, it is considered that by increasing the thickness of the gold layer 70, an attachment amount of the antibody 72 on the front surface of the gold layer 70 is increased, and thereby it becomes possible to capture a larger number of the antigens 74 by the antibodies 72.

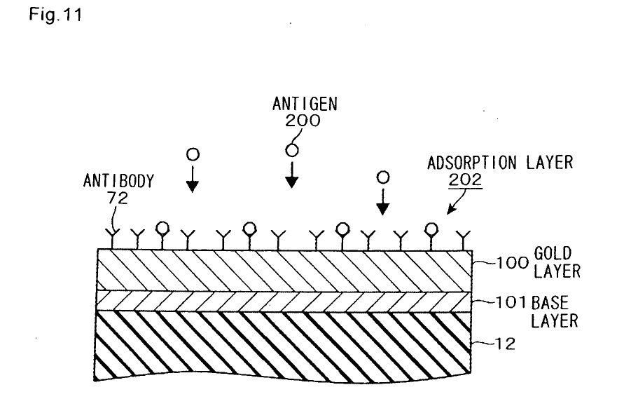

Further, in the above-described embodiment, the thickness of the gold layer 70 is set to 3000 Å or more, and is set to 3000 Å in this example, thereby enabling the following effect to be obtained. For example, chromium being the metal of the base layer 71 to be used for increasing the adhesion force between the gold layer 70 and the quartz-crystal piece 21 gradually diffuses into the gold layer 70 as time passes. When a thickness of the gold layer 100 is 2000 Å as is a conventional quartz-crystal sensor shown in FIG. 11 and FIG. 12, chromium precipitates to the front surface of the gold layer 100 for half a year to one year, and by the above precipitated chromium, antibodies 201 attaching to the front surface of the gold layer 100 are desorbed to shorten a usable life of the quartz-crystal sensor, but by setting the thickness of the gold layer 70 to 3000 Å, it takes one year or longer for chromium to precipitate to the front surface of the gold layer 100, and thus the effect of extending a usable life of the quartz-crystal sensor also exists.

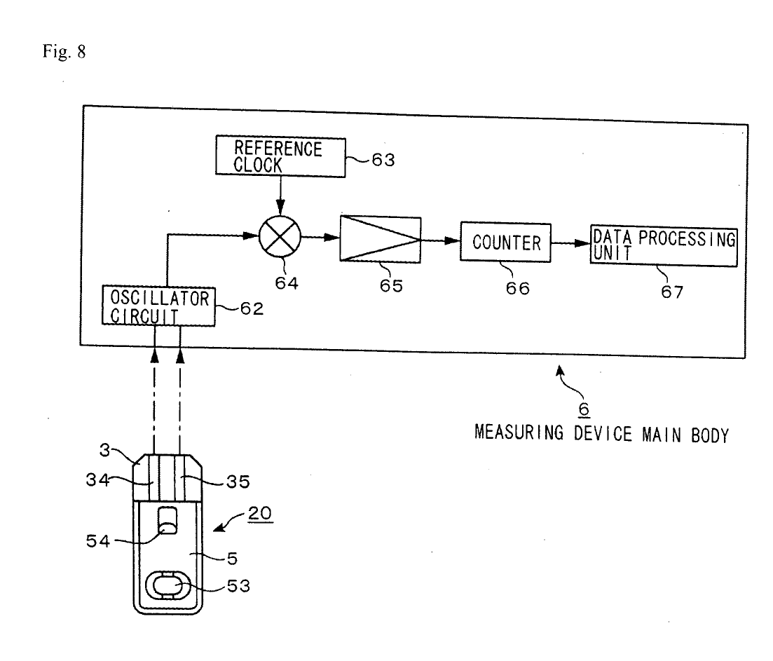

Further, the above-described quartz-crystal sensor 20 is used as a sensing unit of a sensing instrument when connected to a measuring device main body 7 having a configuration as shown in FIG. 8 that is a block diagram, for example. In FIG. 8, 62 denotes an oscillator circuit oscillating the quartz-crystal piece 21 of the quartz-crystal sensor 20, 63 denotes a reference clock generating unit generating a reference frequency signal, and 64 denotes a frequency difference detector formed by, for example, a heterodyne detector, which, based on a frequency signal from the oscillator circuit 62 and a clock signal from the reference clock generating unit 63, extracts a frequency signal corresponding to a frequency difference therebetween. 65 denotes an amplifying unit, 66 denotes a counter counting a frequency of an output signal from the amplifying unit 65, and 67 denotes a data processing unit.

The frequency of the quartz-crystal sensor 20 is 9.2 MHz, and thus as the frequency of the reference clock generating unit 63, for example, 10 MHz is selected. When the antigen 74 being a substance to be measured, which is, for example, dioxin, is not adsorbed to the above-described adsorption layer 7 provided on the quartz-crystal resonator 2 of the quartz-crystal sensor 20, the frequency difference detector 64 outputs a frequency signal (frequency difference signal) corresponding to 1 MHz that is a difference between the frequency from a quartz-crystal sensor side and the frequency of the reference clock, but when the antigen 74 contained in the sample solution is adsorbed to the adsorption layer 7 on the quartz-crystal resonator 2, the natural frequency of the quartz-crystal resonator 2 changes and thereby the frequency difference signal also changes, so that a counter value in the counter 66 changes, thereby enabling the concentration of the substance to be measured or the presence/absence of the substance to be detected.

### EXAMPLES

Experiments that have been performed to confirm the effect of the present invention will be explained.

### Example 1

In the quartz-crystal sensor 20 shown in FIG. 1, the adsorption layer 7 was formed on the front surface of the electrode 22 composed of the gold layer 70 having the thickness of 3000 Å and the base layer 71 having the thickness of 100 Å with the antibodies 72. The above adsorption layer 7 was formed in the following manner. First, 0.2 ml of a buffer solution was supplied into the solution storage space 45, and next 0.2 ml of a sample solution in which 100 μg/ml of a protein called BSA (Bovine Serum Albumin) being the antibody 72 is contained was supplied into the solution storage space 45. Thereby, the antibody 72 attached to the front surface of the electrode 22 and the adsorption layer 7 was formed.

After the adsorption layer 7 was formed, 1 ml of a sample solution in which 10 μg/ml of, for example, a mouse IGa being the antigen 74 is contained was injected into the injection port 53 of the quartz-crystal sensor. Then, an amount of the antigen 74 adsorbed to the adsorption layer 7 on the front surface of the electrode 22 was obtained by taking a difference between the natural frequency of the quartz-crystal resonator 2 before the antigen 74 is adsorbed to the adsorption layer 7 and the natural frequency of the quartz-crystal resonator 2 after the antigen 74 is adsorbed to the adsorption layer 7.

### Example 2

In the same manner as that of Example 1 except that the thickness of the gold layer 70 was set to 4000 Å, the adsorption layer 7 was formed, and thereafter a sample solution in which a mouse IGg is contained was injected to obtain an amount of the antigen 74 adsorbed to the adsorption layer 7 on the front surface of the electrode 22.

### Example 3

The same experiment as that of Example 2 except that the thickness of the gold layer was set to 5000 Å was performed.

### Example 4

The same experiment as that of Example 2 except that the thickness of the gold layer was set to 6000 Å was performed.

### Example 5

The same experiment as that of Example 2 except that the thickness of the gold layer was set to 7000 Å was performed.

### Comparative Example 1

In the same manner as that of Example 1 except that the thickness of the gold layer 70 was set to 1000 Å, the adsorption layer 7 was formed, and thereafter a sample solution in which a mouse IGg is contained was injected to obtain an amount of the antigen 74 adsorbed to the adsorption layer 7 on the front surface of the electrode 22.

### Comparative Example 2

In the same manner as that of Example 1 except that the thickness of the gold layer 70 was set to 2000 Å, the adsorption layer 7 was formed, and thereafter a sample solution in which a mouse IGg is contained was injected to obtain an amount of the antigen 74 adsorbed to the adsorption layer 7 on the front surface of the electrode 22.

(Results and Discussion)

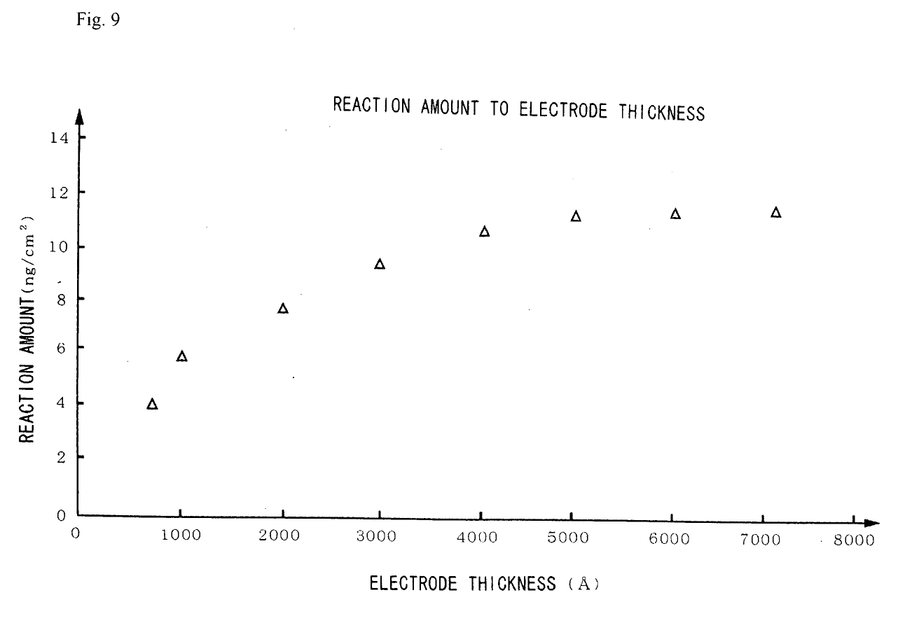

As shown in FIG. 9, the adsorbed amounts of the antigen 74 in Examples 1 to 5 were 9.8 ng/cm², 11.0 ng/cm², 11.7 ng/cm², 12.0 ng/cm², and 12.2 ng/cm² respectively. Further, the adsorbed amounts of the antigen 74 in Comparative Example 1 and Comparative Example 2 were 6.5 ng/cm² and 8.0 ng/cm². That is, it is found that the thickness of the gold layer 100 is increased, thereby increasing the adsorbed amount of the antigen 74 to the adsorption layer 7 formed on the front surface of the gold layer 100. It is inferred that this is because, when, as described above, by sputtering, gold atoms are deposited on the front surface of the base layer 71 to increase the thickness of the gold layer 70, with that, the front surface of the gold layer 70 is coarsened to increase a contact area with the antibody 201 on the front surface of the gold layer 70, and thereby an attachment amount of the antibody 72 on the front surface of the gold layer 100 is increased. Thus, it is found that, when the thickness of the gold layer 100 is set to 3000 Å or more, an attachment amount of the antibody 72 is increased to thereby enable high sensitivity in the piezoelectric sensor to be obtained. Note that, as an expression to obtain a reaction amount based on a measurement frequency, an expression created by Sauerbrey was used.

1. A piezoelectric sensor for sensing an antigen in a sample solution based on a natural frequency of a piezoelectric resonator, the piezoelectric sensor comprising:
a holder having a hole portion formed therein;
a piezoelectric resonator having electrodes that are each made of a gold layer formed on one surface side and the other surface side of a piezoelectric piece via adhesive layers respectively and provided to cover the hole portion and to make the electrode on the other surface side face the hole portion;
an antibody provided on a front surface of the electrode on the one surface side and capturing an antigen by an antigen-antibody reaction; and
conductive paths for connecting the electrodes to an oscillator circuit, and wherein
the gold layer on the one surface side is one formed to be a film having a thickness that is equal to or more than 3000 Å by sputtering.

2. The piezoelectric sensor according to claim 1, wherein
said holder is a wiring substrate provided with conductive paths,
in order to connect the electrodes to conductive paths, a conductive adhesive is provided over the electrodes and conductive paths, and
the adhesive contains a conductive filler and a binder made of an epoxy resin.

3. A sensing instrument comprising:
the piezoelectric sensor according to claim 1; and a measuring device main body for detecting the natural frequency of a piezoelectric resonator.
